(19) United States
(12) Patent Application Publication
(10) Pub. No.: US 2025/0245128 A1
(43) Pub. Date: Jul. 31, 2025

(54) DEBUGGING SYSTEM AND LOG ANALYSIS METHOD

(71) Applicant: Renesas Electronics Corporation, Tokyo (JP)

(72) Inventor: Daiki MATSUSHITA, Tokyo (JP)

(21) Appl. No.: 18/950,434

(22) Filed: Nov. 18, 2024

(30) Foreign Application Priority Data
Jan. 30, 2024 (JP) 2024-011627

(51) Int. Cl. G06F 11/36; G06F 11/07

(52) U.S. Cl. CPC G06F 11/366; G06F 11/0772; G06F 11/079

(57) ABSTRACT

A debugging system includes first and second semiconductor devices and a log analysis apparatus. Each of the first and second semiconductor devices executes software to generate a trace log, a first execution log, and a second execution log. The first semiconductor device transfers the trace log and the first execution log to the log analysis apparatus. The second semiconductor device transfers the trace log and the second execution log to the log analysis apparatus. The log analysis apparatus identifies the processing order of the first execution log and the second execution log based on time stamps given to the trace logs, the first execution log, and the second execution log transferred from the first and second semiconductor devices, and generates analysis data by combining the first and second execution logs according to the identified processing order. The analysis data is used for analyzing a cause of an error.

### CROSS-REFERENCE TO RELATED APPLICATIONS

The disclosure of Japanese Patent Application No. 2024-011627 filed on Jan. 30, 2024 including the specification, drawings and abstract is incorporated herein by reference in its entirety.

### BACKGROUND

The present disclosure relates to a debugging system and a log analysis method.

There are disclosed techniques listed below.

### [Patent Document 1] Japanese Unexamined Patent Application Publication No. 2008-310702

In recent years, with the improvement of the functions and the automated driving level of an advanced driving system, the development scale of in-vehicle software has become larger than ever. Since in-vehicle software greatly relates to safety, convenience, and the like, it is required to efficiently perform high-quality debugging. In debugging of in-vehicle software, data (hereinafter also referred to as an execution log) such as a log and a status of software executed in an in-vehicle device is collected, and the collected execution log is temporarily stored in a memory. The execution log temporarily stored in the memory is read by a log analysis apparatus and used for error analysis. For example, Patent Document 1 discloses a technique of temporarily storing data used for debugging in a memory and reading the data temporarily stored in the memory.

### SUMMARY

In the development of in-vehicle software, it is assumed that debugging is performed using an execution log obtained by operating the software in an actual vehicle. In this case, the execution log obtained by operating the software is collected and then temporarily stored in a memory in the actual vehicle. Since the capacity of the memory is finite, when the memory is full with the collected execution log, the old execution log is overwritten with a new execution log. Thus, it is necessary to transfer the execution log stored in the memory to the log analysis apparatus via a wireless network such as a mobile communication system before the execution log necessary for debugging is overwritten.

However, in a case where the speed at which the execution log is written to the memory (data collection speed) is higher than the speed at which the execution log is transferred from the memory (data transfer speed), it is not possible to transfer all the collected execution logs to the log analysis apparatus. In other words, the execution logs that can be used for analysis are limited, which might hinder efficient debugging.

Other problems and novel features will be apparent from the description of the present specification and the accompanying drawings.

A debugging system according to an embodiment includes a first semiconductor device that is mounted on a first vehicle, a second semiconductor device that is mounted on a second vehicle, and a log analysis apparatus. Each of the first and second semiconductor devices executes software to perform a series of a plurality of related processing, generates a trace log and a plurality of execution logs according to the series of the plurality of related processing, gives a time stamp to each of the trace log and the plurality of execution logs, stores the trace log and the plurality of execution logs to each of which the time stamp is given, and transfers the trace log and at least one of the plurality of execution logs stored to the log analysis apparatus. The plurality of execution logs includes a first execution log and a second execution log. The log analysis apparatus receives the trace log and the first and second execution logs from each of the first and second semiconductor devices. The log analysis apparatus identifies the processing order of the first execution log and the second execution log based on the time stamps given to the trace logs, the first execution log, and the second execution log, generates analysis data by combining the first and second execution logs according to the identified processing order, and analyzes a cause of an error using the analysis data.

A log analysis method according to the embodiment is executed by a debugging system including a first semiconductor device that is mounted on a first vehicle, a second semiconductor device that is mounted on a second vehicle, and a log analysis apparatus. The log analysis method includes a first processing step using each of the first and second semiconductor devices, and a second processing step using the log analysis apparatus. The first processing step includes executing software to perform a series of a plurality of related processing and generating a trace log and a plurality of execution logs according to the series of the plurality of related processing, giving a time stamp to each of the trace log and the plurality of execution logs, storing, in a memory, the trace log and the plurality of execution logs to each of which the time stamp is given, and transferring the trace log and at least one of the plurality of execution logs stored in the memory to the log analysis apparatus. The plurality of execution logs includes a first execution log and a second execution log. The second processing step includes receiving the trace log and the first execution log from the first semiconductor device, receiving the trace log and the second execution log from the second semiconductor device, identifying the processing order of the first execution log and the second execution log based on the time stamps given to the trace logs, the first execution log, and the second execution log, generating analysis data by combining the first and second execution logs according to the identified processing order, and analyzing a cause of an error using the analysis data.

According to the embodiment, analysis data for analyzing a cause of an error is created by combining execution logs transferred from a plurality of semiconductor devices. As a result, it is possible to prepare analysis data over a long period of time that is difficult to realize only with an execution log transferred from one semiconductor device, and possible to efficiently analyze a cause of an error and perform software debugging.

### BRIEF DESCRIPTION OF THE DRAWINGS

FIG. 1 is a block diagram illustrating a configuration of a debugging system according to an embodiment.

FIG. 2 is a block diagram illustrating a configuration of a semiconductor device according to the embodiment.

FIG. 3 is a diagram for describing a trace log and an execution log output from a processor of the semiconductor device according to the embodiment.

FIG. 4 is a diagram for describing the trace log and the execution log transferred to a log analysis apparatus according to the embodiment.

FIG. 5 is a block diagram illustrating a configuration of the log analysis apparatus according to the embodiment.

FIG. 6 is a diagram for describing a difference in an execution flow caused by processing related to conditional branching.

FIG. 7 is a diagram for describing analysis data generated by combining a plurality of execution logs.

FIG. 8 is a diagram for describing a method of combining the plurality of execution logs.

FIG. 9 is a flowchart illustrating an example of an operation of the semiconductor device according to the embodiment.

FIG. 10 is a flowchart illustrating an example of an operation of the log analysis apparatus according to the embodiment.

### DETAILED DESCRIPTION

Hereinafter, an embodiment will be described with reference to the drawings. Note that, since the drawings are simplified ones, the technical scope of the embodiment should not be narrowly interpreted based on the description of the drawings. In addition, the same or similar elements are denoted by the same reference numerals, and redundant description will be omitted.

In the following embodiment, when necessary for convenience, the description will be divided into a plurality of sections or embodiments. However, unless otherwise specified, they are not unrelated to each other but are related to each other in such a way that, for example, one is some or all modifications, application examples, detailed descriptions, supplementary descriptions of the other. In addition, in the following embodiment, as to the number of elements and the like (including number, numerical value, amount, range, and the like), unless otherwise specified or unless clearly limited to a specific number in principle, the number is not limited to this specific number and may be the specific number or more or the specific number or less.

Further, in the following embodiment, the components (including operation steps and the like) are not necessarily unless otherwise specified or considered to be essential obviously essential in principle. Similarly, in the following embodiment, as to the shape, positional relationship, and the like of the components and the like, it is assumed to include those substantially approximate or similar to the shape and the like unless otherwise specified or considered not to be obviously approximate or similar thereto in principle. The same applies to the above number and the like (including number, numerical value, amount, range, and the like).

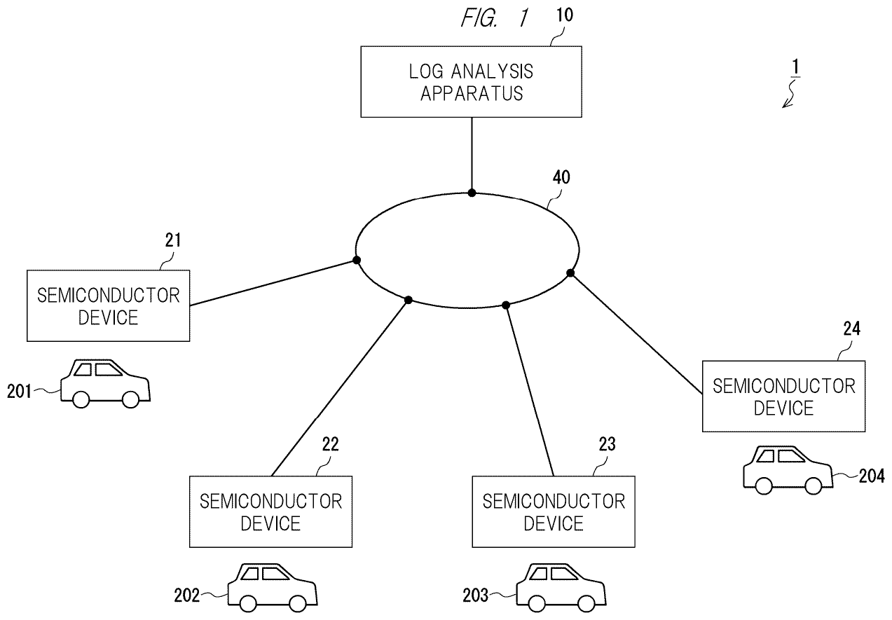

A configuration of a debugging system according to the present embodiment will be described. FIG. 1 is a block diagram illustrating a configuration of a debugging system 1. As illustrated in FIG. 1, the debugging system 1 includes a log analysis apparatus 10, a plurality of semiconductor devices 21 to 24, and a network 40. The semiconductor device 21 is mounted on a vehicle 201. The semiconductor device 22 is mounted on a vehicle 202. The semiconductor device 23 is mounted on a vehicle 203. The semiconductor device 24 is mounted on a vehicle 204. In the present disclosure, when any of the plurality of semiconductor devices 21 to 24 is illustrated, such a semiconductor device is also referred to as a semiconductor device 2. In addition, when any of the plurality of vehicles 201 to 204 is illustrated, such a vehicle is also referred to as a vehicle 20.

The log analysis apparatus 10 is connected to each of the semiconductor devices 21 to 24 via the network 40 such as the Internet or a mobile communication system, and the log analysis apparatus 10 is configured to be able to transmit and receive data with each of the semiconductor devices 21 to 24. Each of the semiconductor devices 21 to 24 transmits an execution log of software to the log analysis apparatus 10 via the network 40. The log analysis apparatus 10 receives an execution log of software from each of the semiconductor devices 21 to 24. In addition, the log analysis apparatus 10 is configured to analyze a cause of an error caused by execution of software based on the execution log and execute debugging of the software.

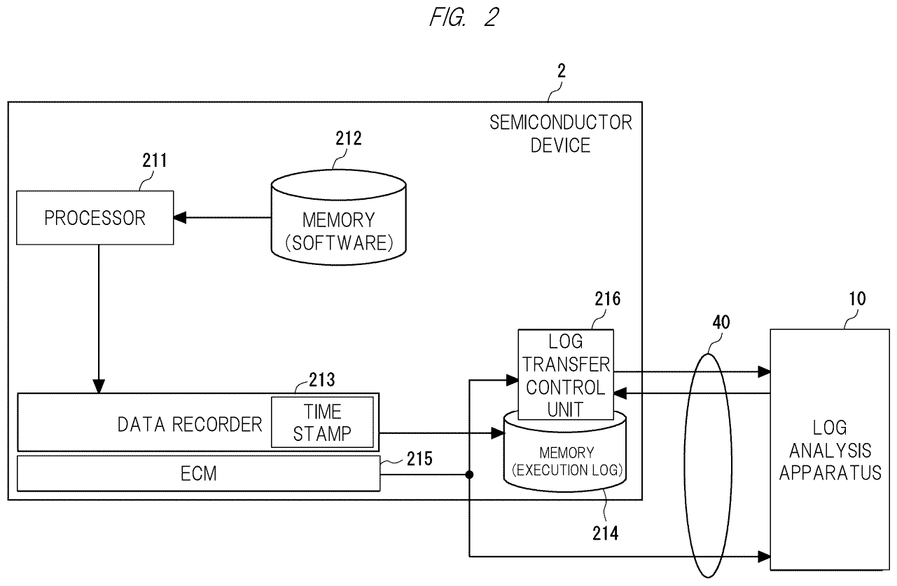

Next, a configuration of the semiconductor device 2 will be described. FIG. 2 is a block diagram illustrating the configuration of the semiconductor device 2. As illustrated in FIG. 2, the semiconductor device 2 includes: a processor 211 such as a central processing unit (CPU); a memory 212 for storing software; a data recorder 213; a memory 214 for storing an execution log and the like; an error control module (ECM) 215; and a log transfer control unit 216.

The processor 211 performs a plurality of processing by executing software. The memory 212 is connected to the processor 211 and stores software to be executed by the processor 211. The software includes various kinds of software such as an operating system (OS) and a device driver. In addition, the processor 211 generates and outputs an execution log corresponding to each of the plurality of processing.

The processor 211 performs a plurality of processing by executing software, and generates an execution log corresponding to each of the plurality of processing. Thus, the plurality of processing and generation of the execution log are performed according to the order of execution of the software. In addition, the processor 211 typically continuously performs a predetermined number of series of related processing. In the present disclosure, a series of execution logs continuously generated according to a series of a plurality of related processing is referred to as an execution log group.

The processor 211 generates a trace log when generating an execution log group. The trace log includes identification information (ID: identification data) for identifying the execution log group. The processor 211 assigns one ID to the execution log group including a plurality of execution logs generated according plurality of related processing, and generates one trace log including the ID. Note that, the ID assigned by the processor 211 is information commonly used in the semiconductor devices 21 to 24.

In addition, the processor 211 outputs a trace log generated according to a series of a plurality of related processing and an execution log group including a plurality of execution logs in the order of the trace log and the execution log group. Thus, by checking the ID included in the trace log output immediately before the execution log group, it is possible to identify to which processing the execution log group is related when generated. Note that, in the present disclosure, a set of a trace log and an execution log group to which the ID included in the trace log is assigned is also referred to as an execution log set.

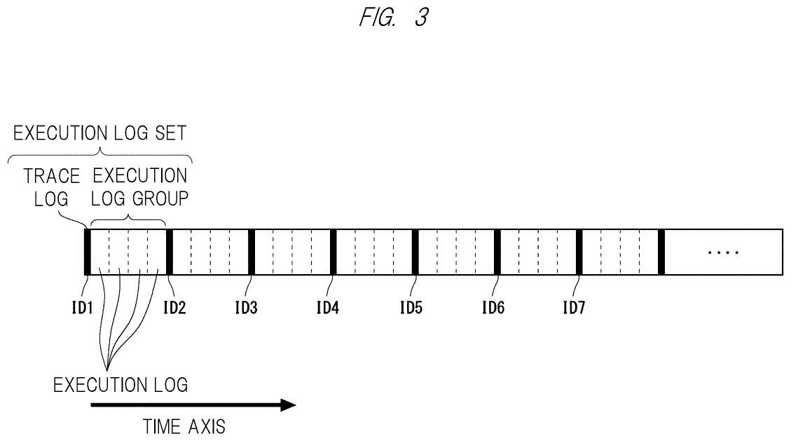

FIG. 3 is a diagram for describing a trace log and an execution log output from the processor 211 of the semiconductor device 2. FIG. 3 illustrates an example in which the processor 211 outputs seven execution log sets. The execution log group included in each execution log set includes four execution logs.

In addition, in the example of FIG. 3, the trace log included in each of the seven execution log sets includes one of seven types of IDs ID 1 to ID 7 along the time axis. For example, the trace log output first includes the ID 1. Thus, the trace log including the ID 1 and the execution log group output immediately after this trace log, in other words, the execution log group located between the trace log including the ID 1 and the trace log including the ID (ID2) different from the trace log including the ID 1 constitute an execution log set of the ID 1. The same applies to the execution log sets of ID 2 to ID 7.

In the example of FIG. 3, the processor 211 outputs the execution log set having the ID 1 to the execution log set having the ID 7 in the order of the ID 1 to the ID 7 along the time axis. That is, it may be understood that the processing identified by the ID 1 to the ID 7 has been sequentially performed by the processor 211.

Returning to FIG. 2, the description of the configuration of the semiconductor device 2 will be continued. The data recorder 213 is connected to the processor 211 and receives a plurality of execution log sets output from the processor 211. The data recorder 213 gives (embeds) a time stamp to each of the trace log and the plurality of execution logs included in the received execution log set. For example, in a case where the data recorder 213 receives the seven execution log sets illustrated in FIG. 3, a time stamp is given to each of the trace log and the four execution logs included in each of the execution log sets in the order of the execution log set having the ID 1 to the execution log set having the ID 7. Note that, the interval at which the time stamps are given is not particularly limited, but at least one time stamp needs to be given to each of the trace log and the execution log. In addition, the data recorder 213 is connected to the memory 214. The data recorder 213 gives a time stamp to each of the trace log and the plurality of execution logs included in the execution log set, and then stores the execution log set in the memory 214. The execution log set to which the time stamp is given is stored in the memory 214 in the order in which the data recorder 213 receives the execution log set from the processor 211.

Since the processor 211 outputs the execution log set one after another, the execution log sets stored by the data recorder 213 eventually exceed the amount of data storage of the memory 214. When the stored execution log sets exceed the data capacity of the memory 214, in order to store a new execution log set, the old execution log set stored in the memory 214 is overwritten with the new execution log set. In other words, the execution log set (the trace log and the execution logs) output from the processor 211 is temporarily stored in the memory 214 until it is overwritten and deleted.

The ECM 215 is configured to determine whether an error has occurred during execution of software. For example, the ECM 215 can determine whether an error has occurred during execution of the software by monitoring an execution log output from the processor 211 and checking whether any of a plurality of pre-registered errors has occurred. If the ECM 215 determines that an error has occurred during execution of the software, it generates an error occurrence notification.

The ECM 215 is connected to the log transfer control unit 216 and transmits an error occurrence notification to the log transfer control unit 216. In addition, the ECM 215 transmits the error occurrence notification and error information to the log analysis apparatus 10 via the network 40. The error information includes information for identifying the semiconductor device 2 in which the error has occurred, information for identifying the type of the error that has occurred, and the like. Note that, the transmission of the error occurrence notification from the ECM 215 to the log transfer control unit 216 may be performed via the processor 211 or may be performed via the log analysis apparatus 10.

The log transfer control unit 216 is connected to the memory 214 and the ECM 215. In addition, the log transfer control unit 216 is connected to the log analysis apparatus 10 via the network 40. The log transfer control unit 216 is configured to read a trace log and execution logs from the memory 214 and transfer the trace log and the execution logs to the log analysis apparatus 10 via the network 40.

In addition, the log transfer control unit 216 receives an error occurrence notification generated by the ECM 215. Upon receiving the error occurrence notification, the log transfer control unit 216 prohibits writing of an execution log set (a trace log and execution logs) from the data recorder 213 to the memory 214. This makes it possible to prevent the trace log and the execution logs, stored in the memory 214, from being overwritten with data and deleted at the timing when it is determined that an error has occurred during execution of software.

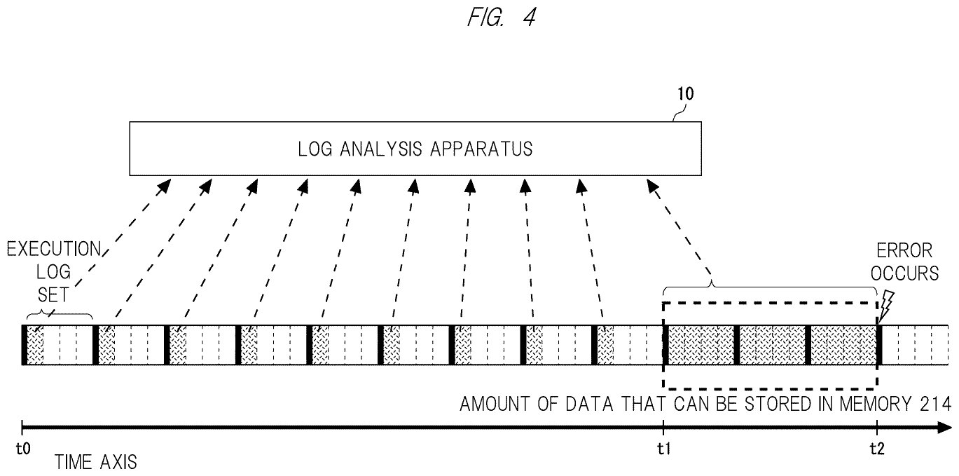

Here, transfer of a trace log and an execution log controlled by the log transfer control unit 216 will be described in detail with reference to FIG. 4. FIG. 4 is a diagram for describing the trace log and the execution log transferred from the memory 214 to the log analysis apparatus 10. FIG. 4 illustrates a plurality of execution log sets output from the data recorder 213 along the time axis. Each execution log set includes a trace log and four execution logs. Each of the four execution logs is also referred to as a first execution log, a second execution log, a third execution log, and a fourth execution log along the time axis.

In FIG. 4, it is assumed that an error has occurred during execution of software at time t2 and writing of an execution log set to the memory 214 is prohibited. In addition, here, it is assumed that the memory 214 has a storage capacity capable of storing three execution log sets illustrated in FIG. 4. Thus, when the error occurs at the time t2 and writing of the execution log set to the memory 214 is prohibited, the execution log sets stored in the memory 214 are three execution log sets illustrated between time t1 and the time t2.

In addition, a plurality of execution log sets illustrated before the time t1 is data temporarily stored in the memory 214 in the past in the order along the time axis. However, at the time t2 when the error occurs, these execution log sets are overwritten with new execution log sets, and are data already deleted from the memory 214. Note that, the execution log set illustrated after the time t2 is not stored in the memory 214 because writing to the memory 214 is prohibited.

The log transfer control unit 216 transfers the trace log and the execution log, stored in the memory 214, to the log analysis apparatus 10 by switching between two transfer modes based on an error occurrence notification generated by the ECM 215. The two transfer modes include a first transfer mode and a second transfer mode. The first transfer mode is a transfer mode in a case where an error occurrence notification has not been received by the log transfer control unit 216, that is, in a case where no error has occurred during execution of software. On the other hand, the second transfer mode is a transfer mode in a case where an error occurrence notification has been received by the log transfer control unit 216, that is, in a case where an error has occurred during execution of the software. In this manner, the log transfer control unit 216 selects one of the first transfer mode and the second transfer mode in response to the error occurrence notification.

When receiving no error occurrence notification, the log transfer control unit 216 controls the log transfer in the first transfer mode. When selecting the first transfer mode, the log transfer control unit 216 reads a trace log and at least one execution log included in each execution log set from the memory 214 based on transfer log designation information, and transfers them to the log analysis apparatus 10. The transfer log designation information is information for designating an execution log to be transferred to the log analysis apparatus 10 among execution logs included in each execution log set.

FIG. 4 illustrates an example in which transfer log designation information designates, as an execution log to be transferred, the first execution log among four execution logs included in each execution log set. The log transfer control unit 216 reads a trace log and the first execution log included in each execution log set based on the transfer log designation information designating the first execution log, and transfers them to the log analysis apparatus 10. Note that, in the first transfer mode, an execution log temporarily stored in the memory 214 in a state where no error occurs is the execution log to be transferred. In the example illustrated in FIG. 4, since an error occurs at the time t2, the execution logs illustrated between the time to and the time t1 are the execution logs to be transferred in the first transfer mode, and the execution logs illustrated between the time t1 and the time t2 are not the execution logs to be transferred in the first transfer mode.

Since the amount of data of execution logs of software generated by the processor 211 is very large along with high functionality of in-vehicle software, it is necessary to write a large amount of execution logs in the memory 214. On the other hand, a transfer speed of an execution log from the memory 214 to the log analysis apparatus 10 is limited depending on a communication protocol of the network 40 such as a mobile communication system. In other words, it should be noted that, when a writing speed of an execution log to the memory 214 is higher than the transfer speed of the execution log from the memory 214, the execution log necessary for analysis might be overwritten with a new execution log and deleted before being transferred from the memory 214.

However, in the first transfer mode, while writing a trace log and execution logs from the data recorder 213 to the memory 214, the log transfer control unit 216 transfers the trace log and the execution logs from the memory 214 to the log analysis apparatus 10. At that time, the log transfer control unit 216 transfers only an execution log designated by transfer log designation information without transferring all the execution logs stored in the memory 214. As a result, the amount of data of execution logs to be transferred is suppressed, and every execution log designated by the transfer log designation information can be transferred from the memory 214 to the log analysis apparatus 10.

In the example illustrated in FIG. 4, the execution log designated by the transfer log designation information is only the first execution log included in each execution log set, but the present invention is not limited thereto. For example, the transfer log designation information may be set to designate the first execution log and the second execution log included in each set as the execution logs to be transferred. In this case, the number of execution logs to be transferred may be determined in consideration of the amount of data of execution logs to be collected, the storage capacity of the memory 214, the writing speed to the memory 214, the transfer speed from the memory 214, and the like.

In addition, an execution log to be designated by transfer log designation information may be set to be different for each ID assigned to an execution log group. For example, the transfer log designation information may be set to designate an execution log in such a way that the first execution log is designated as the execution log to be transferred in an execution log set including an execution log group to which the ID 1 is assigned, and the second execution log is designated as the execution log to be transferred in an execution log set including an execution log group to which the ID 2 is assigned.

Note that, although details will be described later, an execution log designated by transfer log designation information can be set to be different depending on the semiconductor device 2 mounted on the vehicle 20. In the present embodiment, the four semiconductor devices 21 to 24 are mounted on the respective vehicles 201 to 204. For example, the transfer log designation information of the semiconductor device 21 designates the first execution log. The transfer log designation information of the semiconductor device 22 designates the second execution log. The transfer log designation information of the semiconductor device 23 designates the third execution log. The transfer log designation information of the semiconductor device 24 designates the fourth execution log.

Upon receiving an error occurrence notification, the log transfer control unit 216 controls the log transfer in the second transfer mode. As described above, upon receiving the error occurrence notification, the log transfer control unit 216 prohibits writing of a trace log and execution logs from the data recorder 213 to the memory 214. When selecting the second transfer mode, the log transfer control unit 216 reads the trace log and the execution logs from the memory 214 in which writing is prohibited, and transfers the read trace log and execution logs to the log analysis apparatus 10 in response to a log transfer request transmitted from the log analysis apparatus 10.

In the second transfer mode, since writing to the memory 214 is prohibited, the execution log stored in the memory 214 is not overwritten by writing of a new execution log. In other words, the log transfer control unit 216 can transfer all the execution logs stored in the memory 214 to the log analysis apparatus 10 without paying attention to the difference between the writing speed of the execution log to the memory 214 and the transfer speed of the execution log from the memory 214.

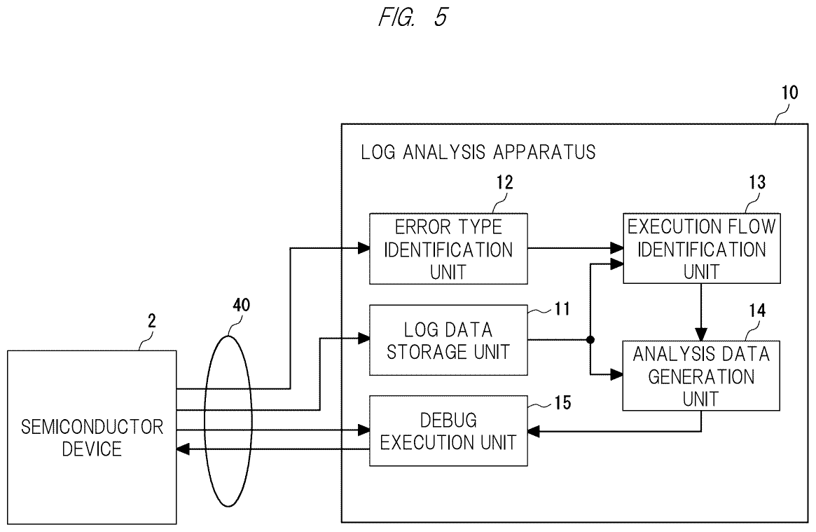

Next, a configuration of the log analysis apparatus 10 will be described. FIG. 5 is a block diagram illustrating a configuration of the log analysis apparatus 10. The log analysis apparatus 10 is connected to the semiconductor device 2 via the network 40, and the log analysis apparatus 10 is configured to be able to perform data communication with the semiconductor device 2. As illustrated in FIG. 5, the log analysis apparatus 10 includes: a log data storage unit 11; an error type identification unit 12; an execution flow identification unit 13; an analysis data generation unit 14; and a debug execution unit 15.

Note that, the log analysis apparatus 10 can be implemented by, for example, a computer that can access the network 40. The computer includes a processor and a memory that stores a program. The processor of the computer implements all or some of the functions of the log analysis apparatus 10 by executing the program stored in the memory.

The log data storage unit 11 is configured to store an execution log set (a trace log and execution logs) transferred from the semiconductor device 2 via the network 40. Note that, the trace log and the execution logs transferred from the semiconductor device 21 are also referred to as a trace log 21 and execution logs 21, and the trace log 21 and the execution logs 21 are also collectively referred to as a log 21. The same applies to the trace log and the execution logs transferred from the semiconductor devices 22 to 24. Thus, the log data storage unit 11 stores the logs 21 to 24 (the trace logs 21 to 24 and the execution logs 21 to 24) transferred from the semiconductor devices 21 to 24.

As described above, the log transfer control unit 216 of the semiconductor device 2 switches the execution log transfer scheme between the first transfer mode and the second transfer mode. In the second transfer mode, in other words, when an error occurs, all execution logs stored in the memory 214 of the semiconductor device 2 are transferred to the log analysis apparatus 10. On the other hand, in the first transfer mode, in other words, when no error occurs, some execution logs stored in the memory 214 of the semiconductor device 2 are transferred to the log analysis apparatus 10.

The error type identification unit 12 is configured to receive error information transmitted from the semiconductor device 2 via the network 40. As described previously, the error information includes information for identifying the semiconductor device 2 in which the error has occurred, information for identifying the type of the error that has occurred, and the like. The error type identification unit 12 is configured to refer to the error information to identify the semiconductor device 2 in which the error has occurred and the type of the error that has occurred, and classify the semiconductor device 2 in which the error has occurred according to the type of the error.

For example, it is assumed that an error has occurred in all the semiconductor devices 21 to 24, but the type of error that has occurred in the semiconductor devices 21 and 22 is different from the type of error that has occurred in the semiconductor devices 23 and 24. In this case, the error type identification unit 12 classifies the semiconductor devices 21 to 24 into two groups of the group of the semiconductor devices 21 and 22 and the group of the semiconductor devices 23 and 24.

The log analysis apparatus 10 can analyze a cause of an error for each execution log transferred from the semiconductor devices 2 classified into the same group by the error type identification unit 12. The error type identification unit 12 generates, as first analysis log information, information for classifying the semiconductor devices 2 according to the type of the error. In the above-described example, the error type identification unit 12 generates the first analysis log information indicating that the semiconductor devices 21 and 22 are classified into the same group and the semiconductor devices 23 and 24 are classified into a group different from the group of the semiconductor devices 21 and 22.

The execution flow identification unit 13 is connected to the log data storage unit 11 and is configured to be able to refer to a trace log stored in the log data storage unit 11. In addition, the execution flow identification unit 13 is connected to the error type identification unit 12 and receives first analysis log information. The execution flow identification unit 13 identifies the semiconductor devices 2 classified into the same group based on the first analysis log information, accesses the log data storage unit 11, and refers to the ID included in the trace log transferred from the specified semiconductor device 2. The execution flow identification unit 13 checks the order of the ID, that is, the processing order of execution logs based on the ID of the referred trace log. The execution flow identification unit 13 thereby identifies an execution flow of processing executed in each of the semiconductor devices 2.

Note that, processing executed by the processor 211 of the semiconductor device 2 includes processing related to conditional branching. Since processing to be performed after the processing related to the conditional branching changes depending on the result of the conditional branching, in a case where the processing related to the conditional branching is included in the processing executed by the processor 211, even if the same error occurs, execution flows of processing executed by the semiconductor devices 21 to 24 do not necessarily coincide with each other.

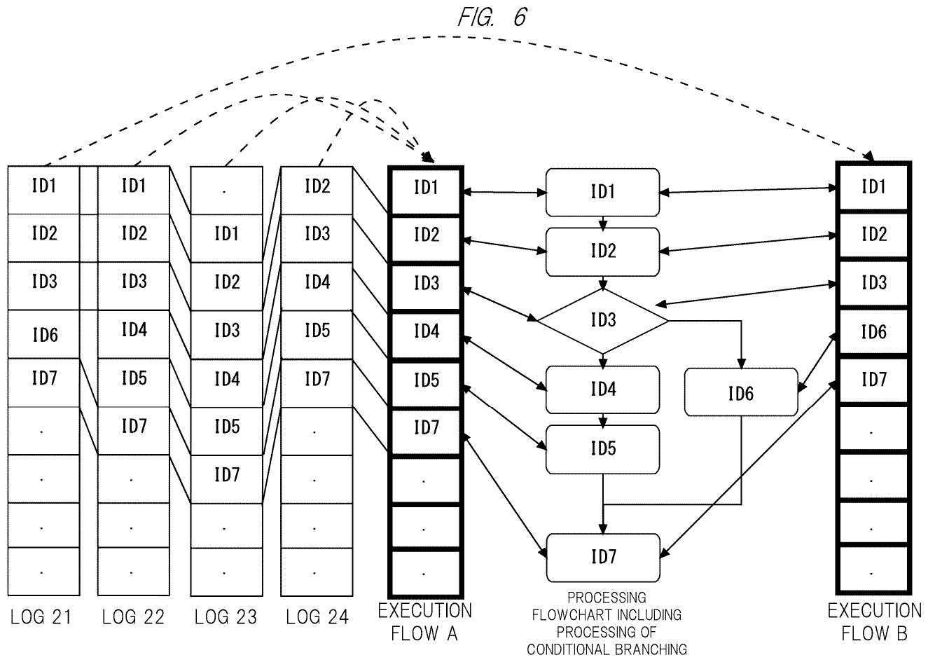

FIG. 6 is a diagram for describing a difference in an execution flow caused by processing related to conditional branching. In the example illustrated in FIG. 6, processing corresponding to a trace log including the ID 3 is the processing related to the conditional branching. Note that, here, processing corresponding to an execution log group identified by the ID 3 is also referred to as processing of the ID 3. The same applies to processing corresponding to an execution log group identified by an ID other than the ID 3.

As illustrated in FIG. 6, after the processing of the ID 3 related to the conditional branching, the processing flowchart branches into a flow for executing processing of the ID 4 and a flow for executing processing of the ID 6. Thus, an execution flow of processing executed by the processor 211 is either an execution flow A including the processing of the ID 4 or an execution flow B including that of the ID 6. The execution flow identification unit 13 identifies the execution flow B of the processing executed by the semiconductor device 21 and the execution flow A of the processing executed by the semiconductor devices 22 to 24 by checking the order of the IDs included in the trace logs 21 to 24 transferred from the semiconductor devices 21 to 24.

The execution flow identification unit 13 identifies the execution flow for all the semiconductor devices 2 classified into the same group, and then subdivides the semiconductor devices 2 classified into the same group based on the difference in the execution flow. In the example of FIG. 6, as a group of the same execution flow, the semiconductor devices are divided into a group of the semiconductor device 21 and a group of the semiconductor devices 22 to 24. The execution flow identification unit 13 generates information for subdividing the semiconductor devices 2 according to the execution flow as second analysis log information. In other words, the second analysis log information is information for classifying the semiconductor devices 2 according to the type of error and the difference in the execution flow.

Note that, since there is a high possibility that there is no execution log that completely matches the entire execution flow of the processing executed by the semiconductor device 2, it goes without saying that the execution flow identified by the execution flow identification unit 13 may be a part of the entire execution flow. The execution flow identification unit 13 may classify the semiconductor devices 2 according to some specific patterns included in the execution flow.

Returning to FIG. 5, the description of the configuration of the log analysis apparatus 10 will be continued. The analysis data generation unit 14 is connected to the log data storage unit 11 and can read trace logs and execution logs stored in the log data storage unit 11. In addition, the analysis data generation unit 14 is connected to the execution flow identification unit 13 and receives second analysis log information. Based on the second analysis log information, the analysis data generation unit 14 reads, from the log data storage unit 11, trace logs and execution logs transferred from the semiconductor devices 2 classified into the same group according to the difference in the type of error and the execution flow, and generates analysis data for analyzing a cause of an error.

During a period in which the log transfer control unit 216 of the semiconductor device 2 controls the log transfer in the first transfer mode, not all the execution logs are transferred. Thus, the analysis data generation unit 14 generates analysis data including the execution log the execution flow, identified based on the second analysis log information, by compensating for an insufficient part in the execution log transferred from one semiconductor device 2 using the execution log transferred from another semiconductor device 2 classified into the same group. In other words, the analysis data is generated by combining the execution logs transferred from the semiconductor devices 2 according to the same execution flow.

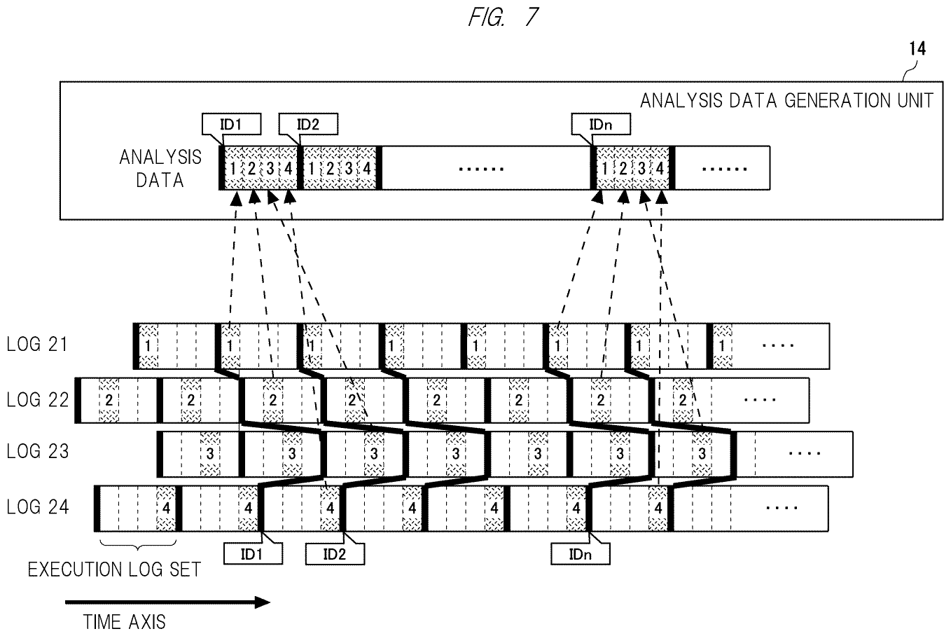

FIG. 7 is a diagram for describing analysis data generated by combining the execution logs 21 to 24 transferred in the first transfer mode from the semiconductor devices 21 to 24 according to the same execution flow. FIG. 7 illustrates the logs 21 to 24 (the trace logs 21 to 24 and the execution logs 21 to 24) transferred in the first transfer mode from the semiconductor devices 21 to 24. In addition, each execution log set includes four execution logs. In this example, it is assumed that the semiconductor device 21 transfers the first execution log among the four execution logs included in each execution log set during a period in which the log transfer is performed in the first transfer mode. Further, the semiconductor device 22 transfers the second execution log among the four execution logs included in each execution log set, the semiconductor device 23 transfers the third execution log among the four execution logs included in each execution log set, and the semiconductor device 24 transfers the fourth execution log among the four execution logs included in each execution log set.

FIG. 7 illustrates an example in which four execution logs included in each of the execution log set of the ID 1, the execution log set of the ID 2, and the execution log set of the ID n transferred from the semiconductor devices 21 to 24 in the first transfer mode are combined to generate analysis data. For example, the analysis data generation unit 14 refers to the trace log including the ID 1, and extracts the first execution log included in the execution log set of the ID 1 transferred from the semiconductor device 21, the second execution log included in the execution log set of the ID 1 transferred from the semiconductor device 22, the third execution log included in the execution log set of the ID 1 transferred from the semiconductor device 23, and the fourth execution log included in the execution log set of the ID 1 transferred from the semiconductor device 24. The analysis data generation unit 14 combines the trace log and the extracted four execution logs to generate an execution log set of the ID 1 as analysis data.

In this manner, the analysis data generation unit 14 refers to the ID included in a trace log, and extracts each of execution logs included in the same execution log set among execution logs transferred in the first transfer mode from the semiconductor devices 21 to 24. The analysis data generation unit 14 combines the plurality of extracted execution logs as execution logs included in one execution log set. The analysis data generation unit 14 generates analysis data including the execution log set including the trace log and the combined execution logs.

In addition, the analysis data generation unit 14 identifies the processing order of execution logs based on time stamps given to the trace log and the execution logs, and combines the execution logs according to the identified processing order. The analysis data generation unit 14 calculates, as an execution log offset time, a difference between the time of the time stamp given to the trace log and the time of the time stamp given to each execution log included in the same execution log set as this trace log. The work of calculating this offset time is performed for all the execution logs to be combined. The analysis data generation unit 14 compares the calculated offset time between the execution logs to identify the processing order of the execution logs transferred from the semiconductor devices 21 to 24, and combines the execution logs included in the same execution log set according to the identified processing order.

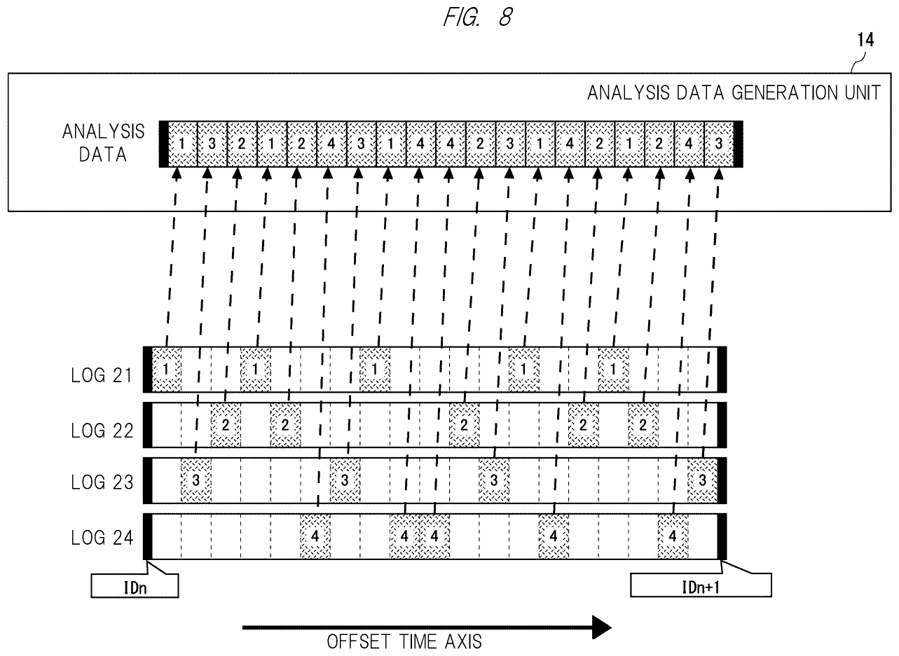

FIG. 8 is a diagram for describing a method of combining the execution logs 21 to 24 transferred in the first transfer mode using time stamps given to the logs 21 to 24 (the trace logs 21 to 24 and the execution logs 21 to 24). FIG. 8 illustrates only one section of the execution flow, that is, only the execution log set of the ID n. In addition, in the execution logs 21 to 24, the execution logs transferred in the first transfer mode are execution logs indicated with numbers. For example, the execution log indicated with the number 1 is an execution log transferred from the semiconductor device 21 in the first transfer mode. In one section illustrated in FIG. 8, the five execution logs 21, the five execution logs 22, the four execution logs 23, and the five execution logs 24 are transferred.

The analysis data generation unit 14 calculates, as the execution log offset time, a difference between the time of the time stamp given to the trace log 21 of the ID n and the time of the time stamp given to each of the five execution logs 21 included in the same execution log set as the trace log 21. The analysis data generation unit 14 similarly calculates the execution log offset time for the five execution logs 22 included in the same execution log set as the trace log 22 of the ID n, the four execution logs 23 included in the same execution log set as the trace log 23 of the ID n, and the five execution logs 24 included in the same execution log set as the trace log 24 of the ID n. The analysis data generation unit 14 compares the magnitude of the calculated execution log offset time to identify the processing order of the execution logs, and combines the execution logs according to this processing order.

Note that, in a case where there is a plurality of types of errors that have occurred in the semiconductor device 2, or in a case where the execution flows of processing are different even in the semiconductor device 2 in which the same error has occurred, there is a plurality of f groups into which the semiconductor devices 2 are classified. Since the analysis of a cause of an error can be performed for each group into which the semiconductor devices 2 are classified, the analysis data generation unit 14 can generate the same number of pieces of analysis data as the number of groups into which the semiconductor devices 2 are classified based on the second analysis log information.

Returning to FIG. 5 again, the description of the configuration of the log analysis apparatus 10 will be continued. The debug execution unit 15 is connected to the semiconductor device 2 via the network 40. The debug execution unit 15 receives an error occurrence notification transmitted from the semiconductor device 2. The debug execution unit 15 transmits a log transfer request to the semiconductor device 2 as a transmission source in response to the error occurrence notification.

In addition, the debug execution unit 15 transmits transfer log designation information to the semiconductor device 2. However, the transfer log designation information may be held in the semiconductor device 2 in advance. In this case, the debug execution unit 15 may be configured to be able to update the transfer log designation information held in the semiconductor device 2 according to an execution log included in analysis data or an analysis result of a cause of an error.

In addition, the debug execution unit 15 is connected to the analysis data generation unit 14 and receives analysis data. The debug execution unit 15 analyzes a cause of an error that has occurred based on a trace log and execution logs included in the analysis data. The debug execution unit 15 performs debugging of software executed by the semiconductor device 2 based on an analysis result of a cause of an error. When there is a plurality of pieces of analysis data, the debug execution unit 15 analyzes the cause of the error for each piece of the analysis data, and reflects the analysis result in the work of debugging the software.

Note that, in the present embodiment, the example in which the debugging system 1 includes the four semiconductor devices 21 to 24 has been described, but the number of semiconductor devices 21 to 24 is not limited to four. In order to analyze a cause of an error, it is more advantageous as the number of the semiconductor devices 2 to which execution logs are transferred, in other words, the number of vehicles on which the semiconductor devices 2 are mounted increases. For example, the log analysis apparatus 10 can analyze data (big data) of a large amount of trace logs and execution logs, transferred from the semiconductor devices 2 mounted on about several tens to 1000 vehicles 20, to debug software.

In addition, depending on a situation in which an error has occurred, the log analysis apparatus 10 may not be able to sufficiently collect execution logs necessary for analyzing a cause of the error. In this case, analysis data generated by the analysis data generation unit 14 lacks a part of an execution log constituting a specific execution flow caused by a specific error, and as a result, the efficiency of analysis of the cause of the error performed by the debug execution unit 15 may be deteriorated. Thus, it is possible to compensate for the insufficient execution log by collecting again an execution log constituting the specific execution flow in which the similar error has occurred.

For example, it is assumed that analysis data is generated based on execution logs transferred from the semiconductor devices 21 and 22 among the semiconductor devices 21 to 24, but sufficient execution logs on an execution flow have failed to be collected only with the execution n logs transferred from the semiconductor devices 21 and 22. When determining that the execution logs included in the analysis data are insufficient, the debug execution unit 15 updates transfer log designation information of the semiconductor devices 21 and 22 so as to compensate for an insufficient execution log. In other words, the transfer log designation information is changed so as to designate an execution log different from the previous execution log. The debug execution unit 15 transmits the updated transfer log designation information to the semiconductor devices 21 and 22. At or after the next time, the semiconductor devices 21 and 22 transfer the execution log in the first transfer mode based on the updated transfer log designation information. As a result, the execution log necessary for analyzing the cause of the error can be collected, thus making it possible to improve the efficiency of analysis of the cause of the error performed by the debug execution unit 15.

Note that, in the above example, it has been described that the transfer log designation information is updated only for the semiconductor devices 21 and 22 in which the error has occurred in the past. However, since there is still a possibility that an insufficient part of the execution log can be collected from the semiconductor devices 23 and 24, the transfer log designation information of the semiconductor devices 23 and 24 may be updated in addition to that of the semiconductor devices 21 and 22. In this case, although the bandwidth of data communication may be squeezed due to transfer of an execution log unnecessary for analysis of the cause of the error, the probability that the execution log necessary for the error analysis can be quickly collected increases.

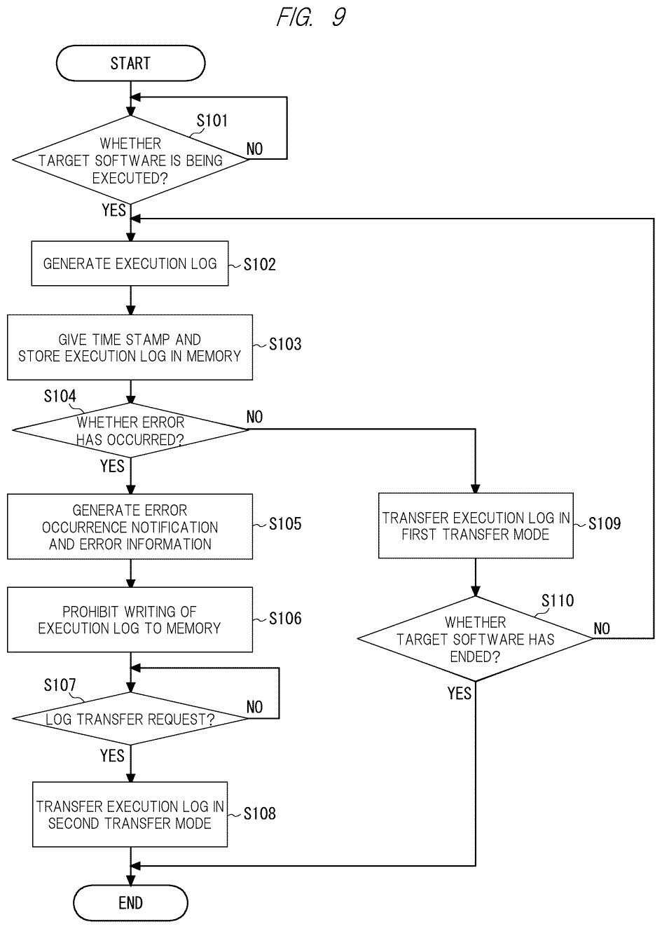

Next, an operation of the semiconductor device 2 according to the present embodiment will be described. FIG. 9 is a flowchart illustrating an example of the operation of the semiconductor device 2 according to the present embodiment. The flowchart of FIG. 9 includes 10 processing steps including Steps S101 to S110. As illustrated in FIG. 9, first, in Step S101, the processor 211 determines whether or not target software is being executed. Since many pieces of software are executed in the semiconductor device 2, in Step S101, it is checked whether or not software to be debugged is being executed.

If it is determined in Step S101 that the target software is being executed (YES in Step S101), the processor 211 performs a plurality of processing based on the execution of the target software, and generates an execution log corresponding to each of the plurality of processing and a trace log including an ID for identifying the execution logs (Step S102).

On the other hand, when it is not determined in Step S101 that the target software is being executed (NO in Step S101), the processor 211 waits in Step S101 until the execution of the target software is started.

Next, in S103, the data recorder 213 gives a time stamp to the trace log and the execution logs, and stores, in the memory 214, the trace log and the execution logs to each of which the time stamp is given.

Next, in Step S104, the ECM215 determines whether or not an error has occurred during the execution of the target software.

If it is determined in Step S104 that an error has occurred during the execution of the target software (YES in Step S104), the ECM215 generates an error occurrence notification and error information (Step S105) and transmits them to the log analysis apparatus 10. At this time, the log analysis apparatus 10 transmits a log transfer request to the target semiconductor device 2 in response to receipt of the error occurrence notification.

Next, in Step S106, the log transfer control unit 216 prohibits writing of a trace log and execution logs to the memory 214 in response to the error occurrence notification.

Next, in Step S107, the log transfer control unit 216 determines whether or not the log transfer request from the log analysis apparatus 10 has been received.

If it is determined in Step S107 that the log transfer request from the log analysis apparatus 10 has been received (YES in Step S107), the log transfer control unit 216 transfers a trace log and execution logs stored in the memory 214 to the log analysis apparatus 10 in the second transfer mode (Step S108). By Step S108, the series of operations of the semiconductor device 2 illustrated in FIG. 9 ends.

On the other hand, if it is not determined in Step S107 that the log transfer request from the log analysis apparatus 10 has been received (NO in Step S107), the log transfer control unit 216 waits in Step S107 until it is determined that the log transfer request has been received.

Meanwhile, if it is not determined in Step S104 that an error has occurred during the execution of the target software (NO in Step S104), the log transfer control unit 216 reads a trace log and at least one execution log, included in each execution log set, from the memory 214 based on the transfer log designation information in the first transfer mode, and transfers them to the log analysis apparatus 10 (Step S109).

Finally, in Step S110, the processor 211 determines whether or not the target software has ended.

If it is determined in Step S110 that the target software has ended (YES in Step S110), the series of operations of the semiconductor device 2 illustrated in FIG. 9 ends.

On the other hand, if it is not determined in Step S110 that the target software has ended (NO in Step S110), the semiconductor device 2 returns to the operation of Step S102.

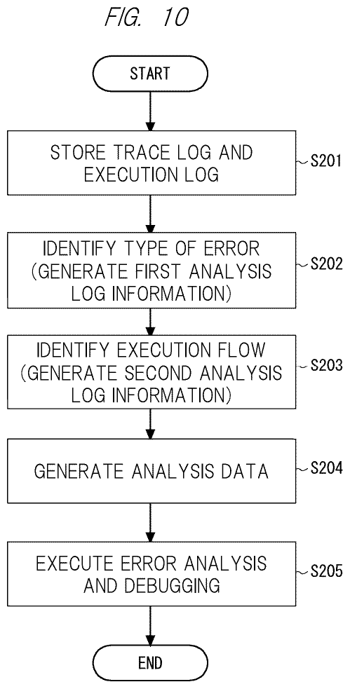

Next, an operation of the log analysis apparatus 10 according to the present embodiment will be described. FIG. 10 is a flowchart illustrating an example of an operation of the log analysis apparatus 10 according to the present embodiment. The flowchart of FIG. 10 includes five processing steps including Steps S201 to S205. As illustrated in FIG. 10, first, in Step S201, the log data storage unit 11 stores an execution log set (a trace log and execution logs) transferred from the semiconductor device 2. More specifically, during a period in which the semiconductor device 2 performs the log transfer in the second transfer mode, the log data storage unit 11 receives the trace log and all the execution logs included in each execution log set from the semiconductor device 2 and stores them. Meanwhile, during a period in which the semiconductor device 2 performs the log transfer in the first transfer mode, the log data storage unit 11 receives the trace log and at least one execution log included in each execution log set from the semiconductor device 2 and stores them.

Next, in Step S202, the error type identification unit 12 refers to error information received from the semiconductor device 2 to identify the type of the error that has occurred in the semiconductor device 2. The error type identification unit 12 classifies the semiconductor device 2 in which the error has occurred according to the identified type of the error, and generates, as first analysis log information, information for classifying the semiconductor device 2 according to the type of the error.

Next, in Step S203, the execution flow identification unit 13 identifies the semiconductor devices 2 classified into the same group according to the type of the error based on the first analysis log information generated by the error type identification unit 12, accesses the log data storage unit 11, and refers to an ID included in the trace log transferred from the identified semiconductor devices 2. The execution flow identification unit 13 checks the order of the ID, that is, the processing order of execution logs based on the ID of the referred trace log. The execution flow identification unit 13 thereby identifies an execution flow of processing executed in each of the semiconductor devices 2. At that time, the execution flow identification unit 13 generates, as second analysis log information, information for classifying the semiconductor devices 2 according to the type of error and a difference in the execution flow.

Next, in Step S204, based on the second analysis log information generated by the execution flow identification unit 13, the analysis data generation unit 14 combines the trace log and the execution logs transferred from the semiconductor devices 2 classified into the same group according to the type of error and the difference in the execution flow to generate analysis data for analyzing a cause of the error. At that time, the analysis data generation unit 14 generates analysis data including the execution log on the execution flow, identified based on the second analysis log information, by compensating for an insufficient part in the execution log transferred from one semiconductor device 2 using the execution log transferred from another semiconductor device 2 classified into the same group, in other words, by combining the execution logs transferred from the plurality of semiconductor devices 2. At that time, the analysis data generation unit 14 combines the execution logs transferred from the plurality of semiconductor devices 2 by identifying the processing order of the execution logs based on time stamps given to the trace log and the execution logs.

Finally, in Step S205, the debug execution unit 15 analyzes the cause of the error that has occurred based on the trace log and the execution logs included in the analysis data generated by the analysis data generation unit 14. The debug execution unit 15 performs debugging of the software executed by the semiconductor device 2 based on an analysis result of the cause of the error.

As described above, the semiconductor device 2 according to the present embodiment switches between the first transfer mode and the second transfer mode, and transfers the trace log and the execution logs stored in the memory 214 to the log analysis apparatus 10. In particular, in the first transfer mode in which writing of the execution logs to the memory 214 and transfer of the execution logs from the memory 214 are simultaneously executed, the semiconductor device 2 does not transfer all the execution logs stored in the memory 214 but transfers only the execution log designated by the transfer log designation information. In other words, even when the data writing speed (data collection speed) of the execution logs is higher than the data transfer speed of the execution logs, by appropriately adjusting the amount of data transfer of the execution logs according to the difference therebetween, it is possible to prevent the execution log to be transferred from being overwritten with a new execution log and deleted before being transferred from the memory 214.

Meanwhile, in the first transfer mode, since only the execution log designated by the transfer log designation information is transferred to the log analysis apparatus 10, only the execution log transferred from one semiconductor device 2 is insufficient for the execution log on the execution flow, which may hamper the analysis of the cause of the error. However, the log analysis apparatus 10 according to the present embodiment combines the execution logs transferred from the plurality of semiconductor devices 2 to complement a portion insufficient only by the execution log transferred from one semiconductor device 2, thereby generating analysis data including the execution log on the execution flow in which the error has occurred. As a result, it is possible to prepare analysis data over a long period of time including a sufficient amount of execution logs, and thereby perform error analysis and debugging operations efficiently.

In the future, with the development and improvement of automated driving technology, the system of an automobile including sensing of the state of the vehicle and control according to the output of the sensor will become more complicated, and the scale (in particular, the amount of data to be used) of in-vehicle software will also become larger. Thus, it is easily conceivable that the amount of data of execution logs necessary for debugging of the in-vehicle software also becomes larger, and a cause of an error also becomes complicated. In other words, it is considered that only data of execution logs temporarily stored in the memory 214 at the time when the error occurs is not at all sufficient as the amount of data for performing efficient error analysis, and there are many situations where data of execution logs for a long time is additionally required. For this reason, it is conceivable that, as in the debugging system 1 of the present disclosure, to dispersedly collect a huge amount of execution logs from semiconductor devices mounted on many vehicles and debug in-vehicle software based on analysis data over a long period of time generated by combining these execution logs becomes more and more useful in the future.

Note that, in the debugging system 1 according to the present embodiment, it is also possible to use a storage area on a cloud to transfer a trace log and an execution log. In this case, the semiconductor device 2 uploads the trace log and the execution log to the storage area on the cloud. The log analysis apparatus 10 downloads the trace log and the execution log uploaded to the storage area on the cloud, and stores the downloaded trace log and execution log in the log data storage unit 11.

In addition, in the semiconductor device 2 according to the present embodiment, the example in which the semiconductor device includes one processor 211 has been described, but the number of processors 211 included in the semiconductor device 2 is not limited to one. Further, the semiconductor device 2 does not need to include one semiconductor chip or one semiconductor device. For example, the memory 214 may be an external storage device.

In addition, although the execution flow identification unit 13 according to the present embodiment has been described as classifying the semiconductor devices 2 according to the difference in the execution flows, the present invention is not limited thereto. The execution flow identification unit 13 can also classify the semiconductor devices 2 in consideration of, for example, information such as a processing time, values of various parameters, and a memory area being used in addition to the difference in the execution flow.

In the foregoing, the invention made by the inventors of the present application has been concretely described based on the embodiments. However, it is needless to say that the present invention is not limited to the foregoing embodiments, and various modifications and alterations can be made within the scope of the present invention.

In addition, as described above, some or all of the functions of the log analysis apparatus 10 can be implemented by causing a CPU to execute a computer program. Further, the same applies to some or all of the functions of the semiconductor device 2.

The above-described program includes a command group (or software code) for causing a computer to perform one or more functions described in the embodiment when the program is read by the computer. The program may be stored in a non-transitory computer-readable medium or a tangible storage medium. As an example and not by way of limitation, the computer-readable medium or the tangible storage medium includes a Random Access Memory (RAM), a Read Only Memory (ROM), a flash memory, a Solid State Drive (SSD) or other memory technology, a CD-ROM, a Digital Versatile Disc (DVD), a Blu-ray (registered trademark) disk or other optical disk storage, a magnetic cassette, a magnetic tape, a magnetic disk storage or other magnetic storage devices. The program may be transmitted on a transitory computer-readable medium or a communication medium. As an example and not by way of limitation, the transitory computer-readable medium or the communication medium includes an electrical, optical, acoustic, or other forms of propagating signal.

What is claimed is:

1. A debugging system comprising:
a first semiconductor device that is mounted on a first vehicle;
a second semiconductor device that is mounted on a second vehicle; and
a log analysis apparatus that is configured to perform data communication with each of the first and second semiconductor devices via a network,
wherein each of the first and second semiconductor devices includes:
a processor that is configured to execute software to perform a series of a plurality of related processing and generate a trace log and a plurality of execution logs according to the series of the plurality of related processing;
a data recorder that is configured to give a time stamp to each of the trace log and the plurality of execution logs;
a memory that is configured to store the trace log and the plurality of execution logs to each of which the time stamp is given; and
a log transfer control unit that is configured to transfer the trace log and at least one of the plurality of execution logs stored in the memory to the log analysis apparatus based on transfer log designation information,
wherein the plurality of execution logs includes a first execution log and a second execution log, and
wherein the log analysis apparatus is configured to:
receive the trace log and the first execution log from the first semiconductor device;
receive the trace log and the second execution log from the second semiconductor device;
identify a processing order of the first execution log and the second execution log based on the time stamps given to the trace logs, the first execution log, and the second execution log from the first and second semiconductor devices;
generate analysis data by combining the first and second execution logs according to the identified processing order; and
analyze a cause of an error using the analysis data.

2. The debugging system according to claim 1,
wherein the transfer log designation information of the first semiconductor device designates the first execution log as an execution log to be transferred from the first semiconductor device to the log analysis apparatus, and
wherein the transfer log designation information of the second semiconductor device designates the second execution log as an execution log to be transferred from the second semiconductor device to the log analysis apparatus.

3. The debugging system according to claim 2,
wherein the log analysis apparatus is configured to:
update the transfer log designation information used in the first or second semiconductor device according to the execution log included in the analysis data or an analysis result of the cause of the error; and
transmit the updated transfer log designation information to the first or second semiconductor device.

4. The debugging system according to claim 1,
wherein the log analysis apparatus is configured to:
calculate a difference between times of the time stamps given to the trace log and the first execution log from the first semiconductor device as a first execution log offset time;
calculate a difference between times of the time stamps given to the trace log and the second execution log from the second semiconductor device as a second execution log offset time; and
identify the processing order of the first execution log and the second execution log by comparing the first execution log offset time and second execution log offset time thus calculated.

5. The debugging system according to claim 1,
wherein the transfer log designation information is information for designating which execution log among the execution logs included in the plurality of execution logs stored in the memory is to be transferred to the log analysis apparatus, and
wherein the number of execution logs to be transferred designated by the transfer log designation information is determined based on a data writing speed to the memory and a data transfer speed from the memory to the log analysis apparatus.

6. The debugging system according to claim 1,
wherein, when generating the trace log, the processor is configured to include identification information for identifying the plurality of execution logs in the trace log.

7. The debugging system according to claim 1,
wherein each of the first and second semiconductor devices further includes an error control module that is configured to determine whether or not an error has occurred during execution of the software,
wherein the error control module is configured to generate an error occurrence notification when determining that an error has occurred during execution of the software, and
wherein the log transfer control unit is configured to prohibit writing of the trace log and the execution logs to the memory when receiving the error occurrence notification.

8. The debugging system according to claim 7,
wherein the error control module is configured to monitor the plurality of execution logs generated by the processor, and determines whether or not an error has occurred during execution of the software by checking whether or not any of a plurality of registered errors has occurred.

9. The debugging system according to claim 7,
wherein the log transfer control unit is configured to:
control data transfer from the memory to the log analysis apparatus by switching between a first transfer mode and a second transfer mode;
select the first transfer mode when not receiving the error occurrence notification;
select the second transfer mode when receiving the error occurrence notification;
when selecting the first transfer mode, transfer the trace log and at least one of the plurality of execution logs stored in the memory to the log analysis apparatus based on the transfer log designation information; and
when selecting the second transfer mode, transfer the trace log and the plurality of execution logs stored in the memory to the log analysis apparatus.

10. The debugging system according to claim 9,
wherein the trace log and the plurality of execution logs transferred to the log analysis apparatus in the second transfer mode are ones stored in the memory before writing to the memory is prohibited based on the error occurrence notification.

11. The debugging system according to claim 9,
wherein when determining that an error has occurred during execution of the software, the error control module is configured to generate error information including information for identifying a semiconductor device in which the error has occurred and information for identifying a type of the error that has occurred,
wherein the processor is configured to:
include identification information for identifying the plurality of execution logs in the trace log when generating the trace log; and
generate a plurality of execution log sets each including the trace log and the plurality of execution logs generated according to the series of the plurality of related processing,
wherein the data recorder is configured to give a time stamp to each of the trace log and the plurality of execution logs included in each execution log set,
wherein the memory is configured to store the plurality of execution log sets each including the trace log and the plurality of execution logs to each of which the time stamp is given, and
wherein the log transfer control unit is configured to:
transfer the plurality of execution log sets each including the trace log and at least one of the plurality of execution logs from the memory to the log analysis apparatus based on the transfer log designation information in the first transfer mode; and
transfer the plurality of execution log sets each including the trace log and the plurality of execution logs from the memory to the log analysis apparatus in the second transfer mode.

12. The debugging system according to claim 11,
wherein the log analysis apparatus includes:
a log data storage unit that is configured to store the plurality of execution log sets transferred from the first and second semiconductor devices in the first and second transfer modes;
an error type identification unit that is configured to generate first analysis log information for classifying the first and second semiconductor devices according to the type of error;
an execution flow identification unit that is configured to generate second analysis log information for classifying the first and second semiconductor devices according to a difference in the type of error and an execution flow;
an analysis data generation unit that is configured to generate the analysis data; and
a debug execution unit that is configured to analyze the cause of the error using the analysis data,
wherein the error type identification unit is configured to:
identify the type of the error that has occurred in the first and second semiconductor devices with reference to the error information transmitted from the first and second semiconductor devices; and
classify the first and second semiconductor devices according to the identified type of error to generate the first analysis log information,
wherein the execution flow identification unit is configured to:
access the log data storage unit to refer to the identification information of the trace logs included in the plurality of execution log sets transferred from the first and second semiconductor devices when the first analysis log information indicates that the first and second semiconductor devices are classified into the same group;
check the processing order of the execution logs based on the identification information of the referred trace logs to identify the execution flow of processing executed in each of the first and second semiconductor devices; and
classify the first and second semiconductor devices according to a difference between the identified execution flows to generate the second analysis log information, and
wherein the analysis data generation unit is configured to:
read, from the log data storage unit, the plurality of execution log sets transferred from the first and second semiconductor devices when the second analysis log information indicates that the first and second semiconductor devices are classified into the same group;
identify the processing order of the first execution log and the second execution log based on the time stamps given to the trace log, the first execution log, and the second execution log included in each of the plurality of read execution log sets; and
generate the analysis data by combining the first and second execution logs according to the identified processing order.

13. The debugging system according to claim 1, further comprising
a storage area on a cloud used for transfer of the trace log and the execution logs from the log transfer control unit to the log analysis apparatus,
wherein the log transfer control unit is configured to upload the trace log and the execution logs to be transferred to the log analysis apparatus to the storage area on the cloud, and
wherein the log analysis apparatus is configured to download the trace log and the execution logs uploaded by the log transfer control unit from the storage area on the cloud.

14. A log analysis method to be executed by a debugging system including a first semiconductor device that is mounted on a first vehicle, a second semiconductor device that is mounted on a second vehicle, and a log analysis apparatus that is configured to perform data communication with each of the first and second semiconductor devices via a network, the log analysis method comprising:
a first processing step using each of the first and second semiconductor devices; and
a second processing step using the log analysis apparatus,
wherein the first processing step includes:
executing software to perform a series of a plurality of related processing and generating a trace log and a plurality of execution logs according to the series of the plurality of related processing;
giving a time stamp to each of the trace log and the plurality of execution logs;
storing, in a memory, the trace log and the plurality of execution logs to each of which the time stamp is given; and
transferring the trace log and at least one of the plurality of execution logs stored in the memory to the log analysis apparatus based on transfer log designation information,
wherein the plurality of execution logs includes a first execution log and a second execution log, and
wherein the second processing step includes:
receiving the trace log and the first execution log from the first semiconductor device;
receiving the trace log and the second execution log from the second semiconductor device;
identifying a processing order of the first execution log and the second execution log based on the time stamps given to the trace logs, the first execution log, and the second execution log from the first and second semiconductor devices;
generating analysis data by combining the first and second execution logs according to the identified processing order; and
analyzing a cause of an error using the analysis data.

15. The log analysis method according to claim 14,
wherein the second processing step further includes:
calculating a difference between times of the time stamps given to the trace log and the first execution log from the first semiconductor device as a first execution log offset time;
calculating a difference between times of the time stamps given to the trace log and the second execution log from the second semiconductor device as a second execution log offset time; and
identifying the processing order f the first execution log and the second execution log by comparing the first execution log offset time and second execution log offset time thus calculated.

16. The log analysis method according to claim 14,
wherein the first processing step further includes:
determining whether or not an error has occurred during execution of the software;
generating an error occurrence notification when determining that an error has occurred during execution of the software; and
prohibiting writing of the trace log and the execution logs to the memory based on the error occurrence notification.

17. The log analysis method according to claim 16,
wherein the first processing step further includes:
controlling data transfer from the memory to the log analysis apparatus by switching between a first transfer mode and a second transfer mode;
selecting the first transfer mode when the error occurrence notification is not generated;
selecting the second transfer mode when the error occurrence notification is generated;
in the first transfer mode, transferring the trace log and at least one of the plurality of execution logs stored in the memory to the log analysis apparatus based on the transfer log designation information; and
in the second transfer mode, transferring the trace log and the plurality of execution logs stored in the memory to the log analysis apparatus.
